(19) United States
(12) Patent Application Publication
(10) Pub. No.: US 2026/0206683 A1
(43) Pub. Date: Jul. 23, 2026

(54) MOWING APPARATUS

(71) Applicant: Lawnix Technology (Nanjing) Co., Ltd., Nanjing (CN)

(72) Inventor: Bin Liu, Nanjing (CN)

(21) Appl. No.: 19/260,239

(22) Filed: Jul. 3, 2025

(30) Foreign Application Priority Data
Jan. 22, 2025 (CN) 202510104734.2
Jan. 22, 2025 (CN) 202520154379.5

(51) Int. Cl. A01D 34/71; A01D 34/00; A01D 69/06

(52) U.S. Cl. CPC A01D 34/71; A01D 34/008; A01D 69/06

(57) ABSTRACT

The present application provides a mowing apparatus, including a housing, a cutting assembly, a wind supplementing assembly, and a differential transmission assembly, the housing having a cavity; the cutting assembly includes a cutting motor and a cutting blade, the cutting motor being located at the cavity, and a cutting driving shaft of the cutting motor being drivingly connected to the cutting blade; the wind supplementing assembly is sleeved on the cutting driving shaft; the differential transmission assembly is arranged at the cavity and configured to drive the wind supplementing assembly, the differential transmission assembly includes a first transmission member linked with the wind supplementing assembly and a differential driving member linked with the first transmission member; and the first transmission member is driven by the differential driving member, so that a rotational speed of the wind supplementing assembly is greater than a rotational speed of the cutting blade.

### CROSS-REFERENCE TO RELATED APPLICATIONS

The present application claims priority to Chinese Patent Application No. 202510104734.2 filed with the China National Intellectual Property Administration on Jan. 22, 2025 and Chinese Patent Application No. 202520154379.5 filed with the China National Intellectual Property Administration on Jan. 22, 2025, which are incorporated herein by reference in their entirety.

### TECHNICAL FIELD

The present application relates to the technical field of landscaping devices, and specifically, to a mowing apparatus.

### BACKGROUND

A conventional mower typically relies on an air flow generated by rotating blades to carry cut grass clippings through a vortex in a cavity to a grass discharge port for discharging during mowing operations. However, during actual operation, especially under complex working conditions such as heavy cutting loads or wet grass, a large amount of grass clippings tend to accumulate inside the cavity. Due to wet, heavy, and sticky grass and excessive dry clippings, blockages may form in an air duct, slowing down a circulation speed of the grass clippings and increasing resistance to air flows. This causes the clippings to accumulate at the grass discharge port, reducing passage efficiency of air and materials within the entire system. When a jamming phenomenon occurs, the blades are forced to work in an environment with greater resistance, which not only increases energy consumption of the machine but also significantly reduces operational efficiency of the blades. Over time, this can affect the overall lifespan and maintenance frequency of the device. To solve these problems and improve overall operational efficiency, a mowing apparatus is needed to reduce blockages in the air duct and increase the air flow speed and stability, thereby ensuring continuous and efficient working capability.

### SUMMARY

The main objective of the present application is to provide a mowing apparatus, so as to solve problems of low passage efficiency and poor mowing efficiency in a cavity of an existing mowing apparatus, achieving an effective improvement in mowing efficiency and grass clippings conveying under complex working conditions, and ensuring collaborative working among all components to achieve optimal operating performance.

To solve the foregoing technical problems, a mowing apparatus is provided according to one aspect of the present application. The mowing apparatus includes a housing, a cutting assembly, a wind supplementing assembly, and a differential transmission assembly; the housing has a cavity; the cutting assembly includes a cutting motor and a cutting blade, the cutting motor is located at the cavity, and a cutting driving shaft of the cutting motor is drivingly connected to the cutting blade, so that the cutting blade is rotatably arranged in the cavity; the wind supplementing assembly is sleeved on the cutting driving shaft; the differential transmission assembly is arranged at the cavity and configured to drive the wind supplementing assembly, the differential transmission assembly includes a first transmission member and a differential driving member, the first transmission member is linked with the wind supplementing assembly, and the differential driving member is linked with the first transmission member; and the first transmission member is driven by the differential driving member, so that a rotational speed of the wind supplementing assembly is greater than a rotational speed of the cutting blade.

With such setting, compared with a conventional design in which an air flow is generated by only relying on rotation of the blade, to generate a limited air flow condition, in the present application, the wind supplementing assembly is sleeved on the cutting driving shaft, and the differential transmission assembly is relied on to achieve a supercharging function, thereby improving air circulation effectiveness. The first transmission member is linked with the wind supplementing assembly, and the differential driving member is linked with the first transmission member. The first transmission member is driven by the differential driving member, so that the rotational speed of the wind supplementing assembly is always greater than the rotational speed of the cutting blade, thereby effectively enhancing a circulation capability of the air flow in the cavity during a mowing operation of the mowing apparatus. Not only efficiency of pushing and expelling the grass clippings in the cavity stage by stage is enhanced, but also a smooth condition in the cavity is maintained, thereby improving mowing efficiency of the mowing apparatus. A collection effect of the grass clippings is optimized, the grass clippings are prevented from scattering around, comprehensive upgrading of a cleaning and energy saving capability is implemented, and user experience is improved.

In addition, the cutting assembly and the wind supplementing assembly are independently designed, so that the mowing apparatus can maintain good performance under different cutting requirements, thereby improving adaptability and practicability of the mowing apparatus.

Further, introduction of the differential transmission assembly enables the mowing apparatus to generate a stronger air flow during a mowing operation. The apparatus is not only applicable to a common lawn, but also can maintain high-efficient mowing and grass clippings collection in complex environments such as high grass and wet grass, thereby improving environmental adaptability of a mower. In an embodiment, this design enables the mowing apparatus to maintain a good working performance and grass clippings management effect when the mowing apparatus faces different lawn conditions, for example, on a fine lawn in a golf course or on high grass in an agronomic place, thereby greatly improving mowing efficiency and user satisfaction.

In an embodiment, a power source of the differential transmission assembly is the cutting assembly, and the cutting driving shaft and the wind supplementing assembly are arranged coaxially.

With such setting, the cutting driving shaft is configured as the differential driving member, and the differential driving member and the wind supplementing assembly are arranged coaxially, which facilitates reducing an additional power apparatus requirement, thereby achieving compactness of an entire structure of the mowing apparatus and minimizing energy loss, thereby improving overall system efficiency. In addition, the wind supplementing assembly can operate at a frequency greater than a rotation frequency of the blade, not only enhancing internal air circulation, but also facilitating the balance of amplitude stress experienced by the entire apparatus, avoiding potential vibration or wear problems, effectively expanding a processing range of a conventional mowing apparatus and relieving load pressure caused by a special condition to an operation, enabling smooth handling of complex tasks and broadening the practical application space with convenient and flexible capabilities.

In an embodiment, the wind supplementing assembly includes a first wind supplementing fan and a transmission fitting member, where the first wind supplementing fan is sleeved on the cutting driving shaft; and the transmission fitting member is connected to the first wind supplementing fan and coupled to the first transmission member; where the first wind supplementing fan is connected to an axial end surface of the transmission fitting member.

With such setting, by setting the wind supplementing assembly into a structural form including the first wind supplementing fan and the transmission fitting member, an augmented air flow pushing force in a high-speed rotation state is formed. The first wind supplementing fan is closely coupled to the transmission fitting member through the end surface, facilitating reducing a possibility that a local configuration bears impact and vibration, achieving a good rotation balance feature with minimum energy consumption, and achieving reliability of power transmission of the differential transmission assembly.

In an embodiment, the first transmission member includes a first gear structure and a fixing bracket, the cutting driving shaft is drivingly connected to the first gear structure, and the first gear structure has a first tooth structure; the fixing bracket is arranged at the cavity and the fixing bracket is connected to the housing, the fixing bracket is provided with at least two planet gears, and each of the at least two planet gears has a second tooth structure configured to mesh with the first tooth structure; and the transmission fitting member includes a second gear structure, the second gear structure is sleeved on the cutting driving shaft, and the second gear structure has a third tooth structure configured to mesh with the second tooth structure.

With such setting, by setting the first transmission member into a structural form including the first gear structure and the fixing bracket, the first gear structure plays a role of power transmission, and the fixing bracket plays a role of mounting and supporting the at least two planet gears, to ensure rotation reliability of the at least two planet gears and power transmission reliability, so as to set the rotational speed of the wind supplementing assembly to be greater than the rotational speed of the cutting blade, thereby ensuring that both the flux and the flow rate of the air flow in the cavity are effectively increased.

In an embodiment, a value range of a transmission ratio i of the differential transmission assembly satisfies: i>0.01; a value range of a rotational speed v1 of the cutting motor satisfies: 2000 rpm≤v1≤5000 rpm; and/or a value range of a rotational speed v2 of the wind supplementing assembly satisfies: v2>2000 rpm.

With such setting, by properly optimizing the value range of the transmission ratio i of the differential transmission assembly, and making i>0.01, it is ensured that the differential transmission assembly is added to the mowing apparatus of the present application, so that the rotational speed of the wind supplementing assembly is greater than the rotational speed of the cutting blade, thereby providing a high-efficient air flow in a cutting process. This air flow not only facilitates quickly discharging the cut grass clippings, but also facilitates cooling the cutting blade and the motor, thereby reducing a temperature increase of the device caused by high-load work for a long time. In addition, by properly optimizing the value range of the rotational speed v1 of the cutting motor, and making 2000 rpm≤v1 ≤5000 rpm, the high-speed air flow facilitates stabilizing operation of the mower, reducing ground resistance and body vibration, improving mowing fineness and mobility, avoiding seriously affecting mowing efficiency of the mowing apparatus due to an excessively small rotational speed v1 of the cutting motor, and also avoiding that the lawn cannot be effectively cut by the mowing apparatus in a mowing operation process due to an excessively large rotational speed v1 of the cutting motor. Further, by properly optimizing the value range of the rotational speed v2 of the wind supplementing assembly, and making v2>2000 rpm, on the premise that it is ensured that the rotational speed of the wind supplementing assembly is greater than the rotational speed of the cutting blade, it is prevented that both the flux and the flow rate of air flow in the cavity cannot meet a requirement for cutting grass due to the rotational speed v2 of the wind supplementing assembly being excessively small, thereby improving mowing efficiency of the mowing apparatus.

In an embodiment, the value range of the transmission ratio i of the differential transmission assembly satisfies: 0.2≤i≤0.7.

With such setting, by properly optimizing the value range of the transmission ratio i of the differential transmission assembly, the rotational speed of the wind supplementing assembly and the rotational speed of the cutting blade may be optimized according to different mowing requirements and environmental conditions, so that the mowing apparatus is applicable to various scenarios from home gardens to professional lawn maintenance. In addition, an accurate transmission ratio is set, so that the mowing apparatus can automatically adjust the optimum rotational speed of the wind supplementing assembly according to different lawn conditions and mowing requirements. Regardless of small-range mowing of a family garden or large-area maintenance of a professional lawn, the grass clippings can be efficiently and accurately collected and managed, thereby improving versatility and user convenience of the mowing apparatus.

In an embodiment, the mowing apparatus further includes a second wind supplementing fan, and the second wind supplementing fan is sleeved on the cutting driving shaft and is connected to an axial end surface of the differential transmission assembly, where the second wind supplementing fan and the first gear structure are integrally formed; and/or, the second wind supplementing fan is connected to an axial end surface of the first gear structure.

With setting of the second wind supplementing fan, the second wind supplementing fan is caused to rotate in a process in which the cutting driving shaft drives the first gear structure to rotate, further increasing the air flux and flow rate in the cavity, thereby improving mowing efficiency of the mowing apparatus, and further improving mowing performance of the mowing apparatus. The second wind supplementing fan and the first gear structure are integrally formed, which is beneficial to simplifying the structure, thereby reducing processing and manufacturing costs of the mowing apparatus, and further beneficial to improving connection reliability between the second wind supplementing fan and the first gear structure, so as to ensure that in a rotation process of the first gear structure, the second wind supplementing fan rotates accordingly.

In addition, in an embodiment, addition of the second wind supplementing fan further enhances strength and coverage of the air flow, can effectively improve the collection efficiency of the grass clippings especially when the mowing area is large, which is applicable to a mowing operation in a large lawn or grassland. The integrally formed second wind supplementing fan and first gear structure not only ensure structural strength of the wind supplementing assembly, but also optimize air flow distribution, so that when the mowing apparatus processes a large lawn, such as a city park or a stadium, the mowing apparatus can gather and collect grass clippings more effectively, thereby reducing subsequent cleaning work and improving overall working efficiency.

With such setting, by means of the structural form of connecting the second wind supplementing fan to the axial end surface of the first gear structure, it is ensured that the connection between the second wind supplementing fan and the first gear structure does not cause a relatively large peripheral size of the entire structure of the mowing apparatus, thereby ensuring compactness of the entire structure of the mowing apparatus, and facilitating miniaturized design of the mowing apparatus.

In an embodiment, a ratio of a fan blade diameter D1 of the wind supplementing assembly to a cutting diameter D of the cutting blade satisfies: 0.05≤D1/D≤0.7.

With such setting, by properly optimizing a value range of the ratio of the fan blade diameter D1 of the wind supplementing assembly to the cutting diameter D of the cutting blade, it is beneficial to properly adjusting a radial gap between the wind supplementing assembly and the cutting blade, to optimize distribution of the air flow, so that in a process of a mowing operation of the mowing apparatus, mowing efficiency of the mowing apparatus is ensured, and the mowing apparatus can perform effective cutting in a quieter and efficient manner as much as possible, thereby providing a more comfortable operating environment for the user.

A mowing apparatus is provided according to another aspect of the present application. The mowing apparatus includes a housing, a cutting assembly, a wind supplementing assembly, and a differential transmission assembly; the housing has a cavity; the cutting assembly includes a cutting motor and a cutting blade, the cutting motor is located at the cavity, and a cutting driving shaft of the cutting motor is drivingly connected to the cutting blade, so that the cutting blade is rotatably arranged in the cavity; the wind supplementing assembly is sleeved on the cutting driving shaft; the differential transmission assembly is arranged at the cavity and configured to connect to the wind supplementing assembly; and the differential transmission assembly includes a first transmission member and a differential driving member, the differential driving member is a wind supplementing motor, the wind supplementing motor is arranged at the cavity, the wind supplementing motor has a fan driving shaft, the fan driving shaft is linked with the first transmission member, and the first transmission member is linked with the wind supplementing assembly; where the first transmission member is driven by the differential driving member, so that a rotational speed of the wind supplementing assembly is greater than a rotational speed of the cutting blade.

With such setting, compared with a conventional design in which a flow of air is generated by only relying on rotation of the blade, a limited flow condition is generated, in the present application, the wind supplementing assembly is arranged on the cutting driving shaft, and the differential transmission assembly is relied on to achieve a supercharging function, thereby improving air circulation effectiveness. The fan driving shaft is linked with the first transmission member, and the first transmission member is linked with the wind supplementing assembly. The first transmission member is driven by the differential driving member, so that the rotational speed of the wind supplementing assembly is always greater than the rotational speed of the cutting blade, thereby effectively enhancing a circulation capability of the air flow in the cavity during a mowing operation of the mowing apparatus. Not only efficiency of pushing and expelling the grass clippings in the cavity stage by stage is enhanced, but also a smooth condition in the cavity is maintained, thereby improving mowing efficiency of the mowing apparatus. A collection effect of the grass clippings is optimized, the grass clippings are prevented from scattering around, comprehensive upgrading of a cleaning and energy saving capability is implemented, and user experience is improved.

In addition, by introducing the wind supplementing motor, the mowing apparatus can be flexibly adjusted for different lawn conditions or different working modes, so that the wind supplementing motor can adjust output power thereof according to an actual requirement of a mowing process and maintain stable and highly efficient transmission, thereby implementing more accurate energy consumption control and ensuring operation economy of the apparatus. For example, when faced with a relatively thick lawn, power of the wind supplementing motor can be independently increased to enhance an air flow effect, without replacing or adjusting a working condition of the cutting assembly. This independent transmission design of the wind supplementing motor not only reduces a mechanical failure risk caused by overload or imbalance, but also can achieve power isolation, reduce noise and vibration, and improve overall stability and comfort of the apparatus.

In addition, introduction of the differential transmission assembly enables the mowing apparatus to generate a stronger air flow during mowing. The apparatus is not only applicable to a common lawn, but also can maintain high-efficient mowing and grass clippings collection in complex environments such as high grass and wet grass, thereby improving environmental adaptability of the mowing apparatus.

Further, by introducing the differential transmission assembly, the rotational speed of the wind supplementing assembly is significantly increased, and air flow strength of the mowing apparatus in a mowing process is effectively enhanced. Not only the mowing efficiency is improved, but also a collection effect of the grass clippings is optimized, so that the grass clippings are prevented from scattering around and user experience is improved. In addition, independent design of the wind supplementing assembly and the cutting assembly enables the mowing apparatus to maintain good performance in different working environments, thereby improving adaptability and practicability of the mowing apparatus.

In an embodiment, the wind supplementing assembly has an axial air guiding channel and a radial air guiding channel that are in communication with each other. The axial air guiding channel is in communication with an air inlet of the cavity, and the radial air guiding channel is in communication with the cavity.

With such setting, by setting the wind supplementing assembly to have a structural form with an axial air guiding channel and a radial air guiding channel that are in communication with each other, a wind inlet direction of wind supplementing passes through the gap of the cutting assembly and/or enters the cavity through the wind supplementing assembly, thereby ensuring wind supplementing reliability of the wind supplementing assembly.

Further, introduction of the axial air guiding channel and the radial air guiding channel further optimizes guiding of air flows, can effectively guide external air to enter the cavity, properly distribute the air flows in the cavity, and generate continuous and stable air flows, which facilitates improving overall aerodynamic efficiency, improving efficiency of collecting grass clippings, effectively cooling the motor and other heat-sensitive components, avoiding a mechanical fault or efficiency reduction caused by a high temperature, reducing impact of air flows disturbance on a cutting path of the blade, and increasing accuracy and working efficiency of cutting.

In an embodiment, the fan driving shaft and the cutting driving shaft are not coaxial.

With such setting, the fan driving shaft and the cutting driving shaft are arranged to be not coaxial, so that the fan driving shaft drives, by independently using the first transmission member, the wind supplementing assembly to rotate, thereby ensuring the rotation reliability of the wind supplementing assembly, and the cutting driving shaft independently drives the cutting blade, thereby ensuring the reliability of the cutting operation performed by the cutting blade.

In an embodiment, the wind supplementing assembly includes a first wind supplementing fan and a transmission fitting member, where the first wind supplementing fan is sleeved on the cutting driving shaft; and the transmission fitting member is connected to the first wind supplementing fan and coupled to the first transmission member.

With such setting, by setting the wind supplementing assembly into a structural form including the first wind supplementing fan and the transmission fitting member, an augmented air flow pushing force in a high-speed rotation state is formed. The first wind supplementing fan is closely coupled to the transmission fitting member through the end surface, facilitating reducing a possibility that a local configuration bears impact and vibration, achieving a good rotation balance feature with minimum energy consumption, and achieving reliability of power transmission of the differential transmission assembly.

In an embodiment, a value range of a transmission ratio i of the differential transmission assembly satisfies: i>1; a value range of a rotational speed v1 of the wind supplementing motor satisfies: v1>3000 rpm; and/or a value range of a rotational speed v2 of the wind supplementing assembly satisfies: v2≤50000 rpm.

With such setting, by properly optimizing the value range of the transmission ratio i of the differential transmission assembly, and making i>1, it is ensured that the differential transmission assembly is added to the mowing apparatus of the present application, so that the rotational speed of the wind supplementing assembly is greater than the rotational speed of the cutting blade, thereby providing a high-efficient air flow in a cutting process. This air flow not only facilitates quickly discharging the cut grass clippings, but also facilitates cooling the cutting blade and the motor, thereby reducing a temperature increase of the device caused by high-load work for a long time. In addition, by properly optimizing the value range of the rotational speed v1 of the wind supplementing motor, and making v1>3000 rpm, the high-speed air flow facilitates stabilizing operation of the mower, reducing ground resistance and body vibration, improving mowing fineness and mobility, and ensuring reliability of driving of the wind supplementing motor to the wind supplementing assembly. In addition, by properly optimizing the value range of the rotational speed v2 of the wind supplementing assembly, and making v2≤50000 pm, on the premise that it is ensured that the rotational speed of the wind supplementing assembly is greater than the rotational speed of the cutting blade, it is prevented that both the flux and the flow rate of air flow in the cavity cannot meet a requirement for cutting grass due to the rotational speed v2 of the wind supplementing assembly being excessively small, thereby improving mowing efficiency of the mowing apparatus.

In an embodiment, the value range of the transmission ratio i of the differential transmission assembly satisfies: 2≤i≤5.

With such setting, by properly optimizing the value range of the transmission ratio i of the differential transmission assembly, the rotational speed of the wind supplementing assembly and the rotational speed of the cutting blade may be optimized according to different mowing requirements and environmental conditions, so that the mowing apparatus is applicable to various scenarios from home gardens to professional lawn maintenance. In addition, an accurate transmission ratio is set, so that the mowing apparatus can automatically adjust the optimum rotational speed of the wind supplementing assembly according to different lawn conditions and mowing requirements. Regardless of small-range mowing of a family garden or large-area maintenance of a professional lawn, the grass clippings can be efficiently and accurately collected and managed, thereby improving versatility and user convenience of the mowing apparatus.

In an embodiment, a value range of a rotational speed v1 of the wind supplementing motor satisfies: 4000 rpm≤v1 ≤60000 rpm.

With such setting, the independent design and the high rotational speed of the wind supplementing motor enable the mowing apparatus to maintain good performance in different working environments, thereby improving adaptability and practicability of the mowing apparatus, and being applicable to various mowing requirements, such as professional garden maintenance and farming operations. In addition, the independently designed wind supplementing motor provides more flexible and high-efficient power support for the mowing apparatus in combination with a high rotational speed range of the wind supplementing motor. Especially in an occasion in which a wind supplementing effect needs to be precisely controlled, such as professional garden maintenance or farming operations, an optimum working state can be adjusted according to an actual requirement, thereby ensuring performance and practicability of the mowing apparatus, and satisfying diversified demands of professional mowing operations.

In an embodiment, a ratio of a fan blade diameter D1 of the wind supplementing assembly to a cutting diameter D of the cutting blade satisfies: 0.05≤D1/D≤0.7.

With such setting, by properly optimizing a value range of the ratio of the fan blade diameter D1 of the wind supplementing assembly to the cutting diameter D of the cutting blade, it is beneficial to properly adjusting a radial gap between the wind supplementing assembly and the cutting blade, to optimize distribution of the air flow, so that in a process of a mowing operation of the mowing apparatus, mowing efficiency of the mowing apparatus is ensured, and the mowing apparatus can perform effective cutting in a quieter and efficient manner as much as possible, thereby providing a more comfortable operating environment for the user.

In an embodiment, the differential transmission assembly is configured to adaptively adjust the rotational speed of the wind supplementing assembly based on at least one of a first wind supplementing signal or a second wind supplementing signal of the mowing apparatus. The first wind supplementing signal is sent by operation on a controller of the mowing apparatus; and/or a second wind supplementing signal is sent based on at least one of a working condition parameter of the mowing apparatus, a cutting parameter of the cutting assembly, or an operating parameter of the mowing apparatus. The working condition parameter of the mowing apparatus includes a grass height, lawn humidity, and grass density. The cutting parameter of the cutting assembly includes a cutting height level, a cutting load, a cutting current, and a cutting rotational speed. The operating parameter of the mowing apparatus includes a travelling speed of the mowing apparatus.

With such setting, by adjusting the rotational speed of the wind supplementing assembly in real time, different lawn conditions such as the height, humidity, and density of the grass can be adapted, and strength of the wind assist is most adaptable in various cutting demands, so as to complete a mowing operation with optimal efficiency, thereby improving overall working efficiency. In addition, an overload situation of the cutting motor can be prevented, thereby improving cutting quality and reducing wear of the blade. In addition, the rotational speed of the wind supplementing assembly can be reduced when unnecessary, thereby reducing energy consumption and improving energy use efficiency of a device. This not only prolongs operating time of the device, but also reduces operating costs. This is beneficial to implementing a high-efficient and precise mowing operation. Such an intelligent mowing apparatus not only improves efficiency and effect of a mowing operation, but also brings more convenient and economic operation experience to a user. Especially in family users, the intelligent mowing apparatus can greatly reduce mowing time and energy, improve satisfaction and confidence levels of the user for the mowing apparatus, and is of great significance to push intelligent upgrade of the mowing apparatus market.

In an embodiment, the controller includes a detection module, a signal transmission module, and a control module, and the detection module is electrically connected to the cutting assembly, to obtain an electrical signal of the cutting assembly; the signal transmission module has a signal receiving end and a signal sending end, and the signal receiving end is communicably connected to the detection module, so as to receive an electrical signal; and the signal sending end is communicably connected to the control module, and the control module is operably connected to the wind supplementing motor, so that the control module adjusts the rotational speed of the wind supplementing motor in real time based on the electrical signal.

Such setting is beneficial to implementing precise regulation on the rotational speed of the wind supplementing motor.

In an embodiment, the mowing apparatus further includes a detector, and the detector is electrically connected to the cutting assembly, to obtain an electrical signal of the cutting assembly; the controller includes a signal transmission module and a control module, the signal transmission module has a signal receiving end and a signal sending end, and the signal receiving end is communicably connected to the detector, so as to receive an electrical signal; and the signal sending end is communicably connected to the control module, and the control module is operably connected to the wind supplementing motor, so that the control module adjusts the rotational speed of the wind supplementing motor in real time based on the electrical signal.

Such setting is beneficial to implementing precise regulation on the rotational speed of the wind supplementing motor.

### BRIEF DESCRIPTION OF THE DRAWINGS

The accompanying drawings forming a part of the present application are used to provide further understanding of the present application. The exemplary embodiments of the present application and the descriptions thereof are used to explain the present application, and do not constitute an improper limitation on the present application. In the accompanying drawings:

FIG. 1 is a schematic cross-sectional structural diagram of a mowing apparatus according to Embodiment 1 of the present application;

FIG. 2 is a schematic diagram of an enlarged structure at A in FIG. 1;

FIG. 3 is a schematic diagram of an exploded structure of a cutting assembly and a differential transmission assembly of the mowing apparatus in FIG. 1;

FIG. 4 is a schematic structural diagram of the mowing apparatus in FIG. 1 from a bottom view;

FIG. 5 is a schematic diagram of an enlarged structure at B in FIG. 4;

FIG. 6 is a schematic cross-sectional structural diagram of a mowing apparatus according to Embodiment 2 of the present application;

FIG. 7 is a schematic diagram of an enlarged structure at C in FIG. 6;

FIG. 8 is a schematic diagram of an exploded structure of a cutting assembly and a transmission assembly of the mowing apparatus in FIG. 6;

FIG. 9 is a schematic structural diagram of the mowing apparatus in FIG. 6 from a bottom view;

FIG. 10 is a schematic diagram of an enlarged structure at D in FIG. 9; and

FIG. 11 is a schematic diagram of analysis in which a rotational speed of a wind supplementing assembly and a rotational speed of a cutting blade are respectively the same and the former is greater than the latter, where in this figure, corresponding wind speed distribution at a grass discharge port is shown in the foregoing two cases.

The foregoing accompanying drawings include the following reference numerals:
10. housing; 11. cavity; 12. accommodating cavity;
20. cutting assembly; 21. cutting motor; 211. cutting driving shaft; 22. cutting blade;
30. wind supplementing assembly; 31. first wind supplementing fan; 32. transmission fitting member; 321. second gear structure; 3211. third tooth structure; 33. axial air guiding channel; 34. radial air guiding channel;
40. differential transmission assembly; 401. first transmission member; 41. first gear structure; 411. first tooth structure; 42. fixing bracket; 421. planet gear; 4211. second tooth structure; 402. wind supplementing motor; 44. fan driving shaft;
50. second wind supplementing fan; 60. spiral retainer ring; 70. flange structure; 80. pad structure; and 90. locking bolt.

### DETAILED DESCRIPTION

The technical solutions in the embodiments of the present application will be described below with reference to the accompanying drawings in the embodiments of the present application. Obviously, the described embodiments are a part of the present application, but not all of them. The following descriptions of at least one exemplary embodiment are actually merely illustrative, and are in no way intended to limit the present application and its application or use. All other embodiments obtained by a person of ordinary skill in the art based on the embodiments of the present application without creative efforts shall fall within the protection scope of the present application.

As shown in FIG. 11, it is found through research that in a region of a grass discharge port of a cutting apparatus, a high-speed region is usually located downward in the middle of the grass discharge port, and a proportion of a range of the entire high-speed region to an area of the grass discharge port is relatively low. In addition, because wet, heavy, and sticky green grass and excessive dry crumbs may form a blockage in an air duct, a circulation speed of the grass clippings is slowed down, and flow resistance of an air flow is increased, thereby further causing an accumulation phenomenon at the grass discharge port. In addition, the accumulation phenomenon reacts on a vortex in a cavity 11, reducing air and substance passing efficiency in an entire system. When a stagnation phenomenon occurs, a cutting blade 22 has to work in a more resistant environment, which increases energy consumption of the machine. In addition, operating efficiency of the cutting blade 22 is also significantly reduced, and the entire life of the device and maintenance frequency may be affected in a long time. To resolve these problems and improve overall operating efficiency, a mowing apparatus is needed, so as to reduce a phenomenon of blockage in the air duct and improve an air flow speed and stability, thereby ensuring a continuous and high-efficient working capability.

Specifically, in FIG. 11, (a) is a schematic simulation diagram that a rotational speed of a wind supplementing assembly 30 is the same as a rotational speed of the cutting blade 22, (b) is a schematic simulation diagram that the rotational speed of the wind supplementing assembly 30 is greater than the rotational speed of the cutting blade 22, (c) is the wind speed distribution at a grass discharge port in the case of (a), and (d) is the wind speed distribution at the grass discharge port in the case of (b). It can be learned that, an increase in the rotational speed of the wind supplementing assembly 30 facilitates increasing the wind speed at the grass discharge port and distribution of a high-speed region, and the distribution of the high-speed region can reduce occurrence of a squeezing phenomenon.

### EMBODIMENT 1

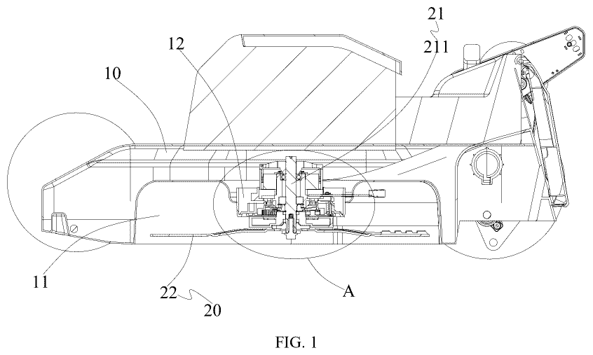

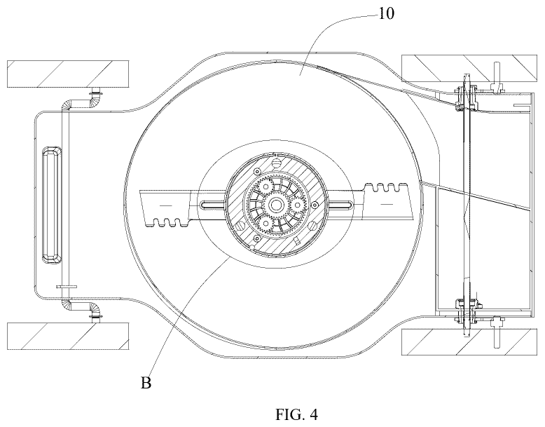

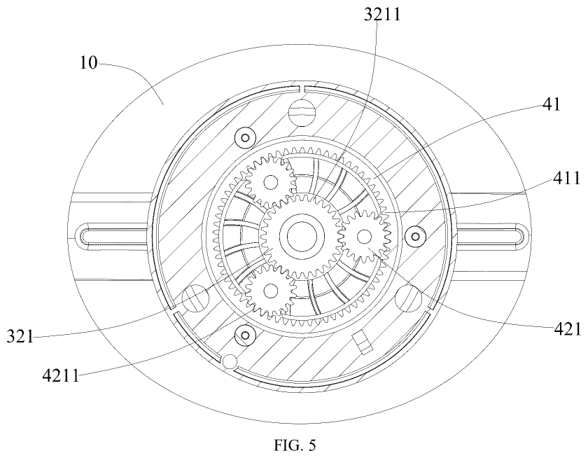

As shown in FIG. 1 to FIG. 5, a mowing apparatus includes a housing 10, a cutting assembly 20, a wind supplementing assembly 30, and a differential transmission assembly 40; the housing 10 has a cavity 11; the cutting assembly 20 includes a cutting motor 21 and a cutting blade 22, the cutting motor 21 is located at the cavity 11, and a cutting driving shaft 211 of the cutting motor 21 is drivingly connected to the cutting blade 22, so that the cutting blade 22 is rotatably arranged in the cavity 11; the wind supplementing assembly 30 is sleeved on the cutting driving shaft 211; and the differential transmission assembly 40 is arranged at the cavity 11 and configured to drive the wind supplementing assembly 30, the differential transmission assembly 40 includes a first transmission member 401 and a differential driving member, the first transmission member 401 is linked with the wind supplementing assembly 30, and the differential driving member is linked with the first transmission member 401; where the first transmission member 401 is driven by the differential driving member, so that a rotational speed of the wind supplementing assembly 30 is greater than a rotational speed of the cutting blade 22.

Compared with a conventional design in which an air flow is generated by only relying on rotation of the blade, to generate a limited air flow condition, in the present application, the wind supplementing assembly 30 is sleeved on the cutting driving shaft 211, and the differential transmission assembly 40 is relied on to achieve a supercharging function, thereby improving air circulation effectiveness. The first transmission member 401 is linked with the wind supplementing assembly 30, and the differential driving member is linked with the first transmission member 401. The first transmission member 401 is driven by the differential driving member, so that the rotational speed of the wind supplementing assembly 30 is always greater than the rotational speed of the cutting blade 22, thereby effectively enhancing a circulation capability of the air flow in the cavity 11 during a mowing operation of the mowing apparatus. Not only efficiency of pushing and expelling the grass clippings in the cavity 11 stage by stage is enhanced, but also a smooth condition in the cavity 11 is maintained, thereby improving mowing efficiency of the mowing apparatus. A collection effect of the grass clippings is optimized, the grass clippings are prevented from scattering around, comprehensive upgrading of a cleaning and energy saving capability is implemented, and user experience is improved.

In addition, the cutting assembly 20 and the wind supplementing assembly 30 are independently designed, so that the mowing apparatus can maintain good performance under different cutting requirements, thereby improving adaptability and practicability of the mowing apparatus.

Further, introduction of the differential transmission assembly 40 enables the mowing apparatus to generate a stronger air flow during a mowing operation. The apparatus is not only applicable to a common lawn, but also can maintain high-efficient mowing and grass clipping collection in complex environments such as high grass and wet grass, thereby improving environmental adaptability of a lawn mower. In an embodiment, this design enables the mowing apparatus to maintain a good working performance and grass clippings management effect when the mowing apparatus faces different lawn conditions, for example, on a fine lawn in a golf course or on high grass in an agronomic place, thereby greatly improving mowing efficiency and user satisfaction.

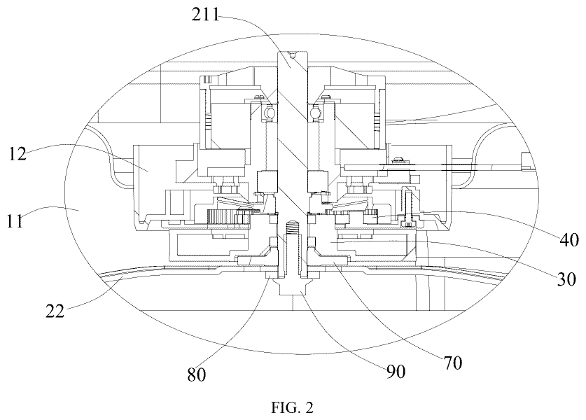

As shown in FIG. 2, the housing 10 further has an accommodating cavity 12, and the cutting motor 21 is located at a communication position between the cavity 11 and the accommodating cavity 12.

In an embodiment, a power source of the differential transmission assembly 40 is the cutting assembly 20, and the cutting driving shaft 211 and the wind supplementing assembly 30 are arranged coaxially. In this way, the cutting driving shaft 211 is configured as the differential driving member, and the differential driving member and the wind supplementing assembly 30 are arranged coaxially, which facilitates reducing an additional power apparatus requirement, thereby achieving compactness of an entire structure of the mowing apparatus and minimizing energy loss, thereby improving overall system efficiency. In addition, the wind supplementing assembly can operate at a frequency greater than a rotation frequency of the blade, not only enhancing internal air circulation, but also facilitating the balance of amplitude stress experienced by the entire apparatus, avoiding potential vibration or wear problems, effectively expanding a processing range of a conventional mowing apparatus and relieving load pressure caused by a special condition to an operation, enabling smooth handling of complex tasks and broadening the practical application space with convenient and flexible capabilities.

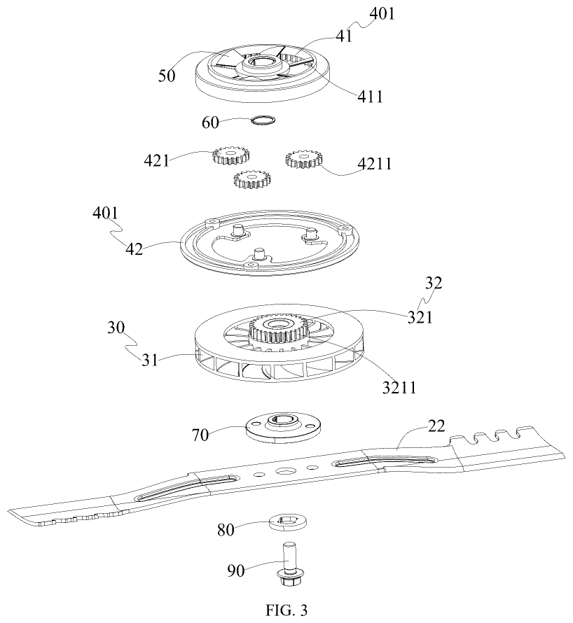

As shown in FIG. 2 and FIG. 3, the wind supplementing assembly 30 includes a first wind supplementing fan 31 and a transmission fitting member 32, where the first wind supplementing fan 31 is sleeved on the cutting driving shaft 211; and the transmission fitting member 32 is connected to the first wind supplementing fan 31 and coupled to the first transmission member 401; where the first wind supplementing fan 31 is connected to an axial end surface of the transmission fitting member 32. In this way, by setting the wind supplementing assembly 30 into a structural form including the first wind supplementing fan 31 and the transmission fitting member 32, an augmented air flow pushing force in a high-speed rotation state is formed. The first wind supplementing fan is closely coupled to the transmission fitting member 32 through the end surface, facilitating reducing a possibility that a local configuration bears impact and vibration, achieving a good rotation balance feature with minimum energy consumption, and achieving reliability of power transmission of the differential transmission assembly 40.

In an embodiment, the first wind supplementing fan 31 and the transmission fitting member 32 are integrally formed. In this way, it is beneficial to simplifying an overall structure of the wind supplementing assembly 30, reducing processing and manufacturing costs of the wind supplementing assembly 30, reducing assembly complexity and possible loosening or wearing risks between assemblies, improving connection stability between the first wind supplementing fan 31 and the transmission fitting member 32 of the wind supplementing assembly 30, and ensuring that power is more direct and smooth when transmitted from the differential transmission assembly 40 to the wind supplementing fan due to coupling of the transmission fitting member 32 to the first transmission member 401, reducing intermediate energy loss, and ensuring wind supplementing effectiveness of the first wind supplementing fan 31.

Further, the integrally formed first wind supplementing fan 31 and transmission fitting member 32 improve structural strength of the wind supplementing assembly 30, reduce deformation caused by high-speed rotation, and are applicable to a mowing environment that needs to be frequently moved and operated, such as agronomy and horticulture. In addition, internal friction and noise are also reduced, so that the mowing apparatus can maintain a stable working status and a relatively low noise level in a long-time high-strength mowing operation, for example, continuously work in a large park or a golf course, thereby improving operation experience of a user, and reducing interference to an ambient environment. The integrally formed first wind supplementing fan 31 and transmission fitting member 32 ensure structural stiffness of the wind supplementing assembly 30 at high-speed rotation, especially in an agronomic or horticultural scenario, for example, frequently moving to different plots or terrains. Structural deformation caused by high-speed rotation can be effectively reduced, a stable working state can be maintained, and a service life of the mowing apparatus is prolonged.

As shown in FIG. 2 to FIG. 5, the first transmission member 401 includes a first gear structure 41 and a fixing bracket 42, the cutting driving shaft 211 is drivingly connected to the first gear structure 41, and the first gear structure 41 has a first tooth structure 411; the fixing bracket 42 is arranged at the cavity 11 and the fixing bracket 42 is connected to the housing 10, the fixing bracket 42 is provided with at least two planet gears 421, and each of the at least two planet gears 421 has a second tooth structure 4211 configured to mesh with the first tooth structure 411; and the transmission fitting member 32 includes a second gear structure 321, the second gear structure 321 is sleeved on the cutting driving shaft 211, and the second gear structure 321 has a third tooth structure 3211 configured to mesh with the second tooth structure 4211. In this way, by setting the first transmission member 401 into a structural form including the first gear structure 41 and the fixing bracket 42, the first gear structure 41 plays a role of power transmission, and the fixing bracket 42 plays a role of mounting and supporting the at least two planet gears 421, to ensure rotation reliability of the at least two planet gears 421 and power transmission reliability, so as to set the rotational speed of the wind supplementing assembly 30 to be greater than the rotational speed of the cutting blade 22, thereby ensuring that both the flux and the flow rate of the air flow in the cavity 11 are effectively increased.

As shown in FIG. 2 to FIG. 5, the fixing bracket 42 is arranged at a communication position between the cavity 11 and the accommodating cavity 12.

In an embodiment, a value range of a transmission ratio i of the differential transmission assembly 40 satisfies: i>0.01; a value range of a rotational speed v1 of the cutting motor 21 satisfies: 2000 rpm≤v1 ≤5000 rpm; and/or a value range of a rotational speed v2 of the wind supplementing assembly 30 satisfies: v2>2000 rpm. In this way, by properly optimizing the value range of the transmission ratio i of the differential transmission assembly 40, and making i>0.01, it is ensured that the differential transmission assembly 40 is added to the mowing apparatus of the present application, so that the rotational speed of the wind supplementing assembly 30 is greater than the rotational speed of the cutting blade 22, thereby providing a high-efficient air flow in a cutting process. This air flow not only facilitates quickly discharging the cut grass clippings, but also facilitates cooling the cutting blade 22 and the motor, thereby reducing a temperature increase of the device caused by high-load work for a long time. In addition, by properly optimizing the value range of the rotational speed v1 of the cutting motor 21, and making 2000 rpm≤v1≤5000 rpm, the high-speed air flow facilitates stabilizing operation of the mower, reducing ground resistance and body vibration, improving mowing fineness and mobility, avoiding seriously affecting mowing efficiency of the mowing apparatus due to an excessively small rotational speed v1 of the cutting motor 21, and also avoiding that the lawn cannot be effectively cut by the mowing apparatus in a mowing operation process due to an excessively large rotational speed v1 of the cutting motor 21. Further, by properly optimizing the value range of the rotational speed v2 of the wind supplementing assembly 30, and making v2>2000 rpm, on the premise that it is ensured that the rotational speed of the wind supplementing assembly 30 is greater than the rotational speed of the cutting blade 22, it is prevented that both the flux and the flow rate of air flow in the cavity 11 cannot meet a requirement for cutting grass due to the rotational speed v2 of the wind supplementing assembly 30 being excessively small,, thereby improving mowing efficiency of the mowing apparatus.

Preferably, the value range of the transmission ratio i of the differential transmission assembly 40 satisfies: 0.2≤i≤0.7. In this way, by properly optimizing the value range of the transmission ratio i of the differential transmission assembly 40, the rotational speed of the wind supplementing assembly 30 and the rotational speed of the cutting blade 22 may be optimized according to different mowing requirements and environmental conditions, so that the mowing apparatus is applicable to various scenarios from home gardens to professional lawn maintenance. In addition, an accurate transmission ratio is set, so that the mowing apparatus can automatically adjust the optimum rotational speed of the wind supplementing assembly 30 according to different lawn conditions and mowing requirements. Regardless of small-range mowing of a family garden or large-area maintenance of a professional lawn, the grass clippings can be efficiently and accurately collected and managed, thereby improving versatility and user convenience of the mowing apparatus.

Further, a value range of a rotational speed v1 of the cutting motor 21 satisfies: 2000 rpm≤v1≤5000 rpm. In this way, the cutting motor 21 with a high rotational speed can provide a faster mowing effect, and is applicable to an occasion in which fast mowing is needed, such as commercial lawn maintenance and a stadium. In addition, in an occasion in which fast mowing needs to be performed, such as commercial lawn maintenance or a stadium, the cutting motor 21 with a high rotational speed is used, so that the mowing speed can be significantly increased, and moreover, a smooth and uniform mowing effect can be ensured, thereby satisfying dual requirements of a professional mowing operation on speed and quality.

Further, a value range of a rotational speed v2 of the wind supplementing assembly 30 satisfies: v2>2000 rpm. In this way, the wind supplementing assembly 30 with a high rotational speed can generate a stronger air flow, thereby improving mowing efficiency and optimizing collection of grass clippings, and is applicable to an occasion in which high-efficient grass clippings management is needed, such as a park or a large greenfield. In addition, the wind supplementing assembly 30 with a high rotational speed enables the mowing apparatus to rapidly gather and collect the cut grass clippings in an occasion in which high-efficient grass clippings management is needed, such as a park or a large greenfield, thereby avoiding spreading of the grass clippings, keeping a clean mowing region, and improving environmental protection performance and user satisfaction of the mowing apparatus.

Further, a rotational speed of the second gear structure 321 is greater than a rotational speed of the first gear structure 41. In this way, a stronger air flow can be generated to assist in cutting, the mowing effect and efficiency of discharging grass clippings are improved, and effective differential driving can be implemented.

As shown in FIG. 3 to FIG. 5, the first tooth structure 411 is inward meshing teeth, the second tooth structure 4211 is outward meshing teeth, and the third tooth structure 3211 is outward meshing teeth. In this way, it is ensured that the cutting driving shaft 211 drives the first gear structure 41 to rotate, and power is transmitted by means of meshing action of the first tooth structure 411 and the second tooth structure 4211. Further, the power continues to be transmitted by means of meshing action of the second tooth structure 4211 and the third tooth structure 3211, to drive the first wind supplementing fan 31.

In an embodiment of the present application that is not shown in the figure, the first tooth structure 411 is outward meshing teeth, the second tooth structure 4211 is outward meshing teeth, and the third tooth structure 3211 is inward meshing teeth. In this way, it is ensured that the cutting driving shaft 211 drives the first gear structure 41 to rotate, and power is transmitted by means of meshing action of the first tooth structure 411 and the second tooth structure 4211. Further, the power continues to be transmitted by means of meshing action of the second tooth structure 4211 and the third tooth structure 3211, to drive the first wind supplementing fan 31.

As shown in FIG. 3, the mowing apparatus further includes a second wind supplementing fan 50, the second wind supplementing fan 50 being sleeved on the cutting driving shaft 211 and being connected to an axial end surface of the differential transmission assembly 40. In this way, with setting of the second wind supplementing fan 50, the second wind supplementing fan 50 is caused to rotate in a process in which the cutting driving shaft 211 drives the first gear structure 41 to rotate, further increasing the air flux and flow rate in the cavity 11, thereby improving mowing efficiency of the mowing apparatus, and further improving mowing performance of the mowing apparatus.

It should be noted that, in an embodiment of the present application, the second wind supplementing fan 50 and the first gear structure 41 are integrally formed. In this way, the second wind supplementing fan 50 and the first gear structure 41 are integrally formed, which is beneficial to simplifying the structure, thereby reducing processing and manufacturing costs of the mowing apparatus, and further beneficial to improving connection reliability between the second wind supplementing fan 50 and the first gear structure 41, so as to ensure that in a rotation process of the first gear structure 41, the second wind supplementing fan 50 rotates accordingly.

In addition, in an embodiment, addition of the second wind supplementing fan 50 further enhances strength and coverage of the air flow, can effectively improve the collection efficiency of the grass clippings especially when the mowing area is large, which is applicable to a mowing operation in a large lawn or grassland. The integrally formed second wind supplementing fan 50 and first gear structure 41 not only ensure structural strength of the wind supplementing assembly 30, but also optimizes air flow distribution, so that when the mowing apparatus processes a large lawn, such as a city park or a stadium, the mowing apparatus can gather and collect grass clippings more effectively, thereby reducing subsequent cleaning work and improving overall working efficiency.

It should be noted that, in another embodiment of the present application, the second wind supplementing fan 50 is connected to an axial end surface of the first gear structure 41. In this way, by means of the structural form of connecting the second wind supplementing fan 50 to the axial end surface of the first gear structure 41, it is ensured that the connection between the second wind supplementing fan and the first gear structure does not cause a relatively large peripheral size of the entire structure of the mowing apparatus, thereby ensuring compactness of the entire structure of the mowing apparatus, and facilitating miniaturized design of the mowing apparatus.

It should be noted that, in an embodiment, a ratio of a fan blade diameter D1 of the wind supplementing assembly 30 to a cutting diameter D of the cutting blade 22 satisfies: 0.05≤D1/D≤0.7. In this way, by properly optimizing a value range of the ratio of the fan blade diameter D1 of the wind supplementing assembly 30 to the cutting diameter D of the cutting blade 22, it is beneficial to properly adjusting a radial gap between the wind supplementing assembly 30 and the cutting blade 22, to optimize distribution of the air flow, so that in a process of a mowing operation of the mowing apparatus, mowing efficiency of the mowing apparatus is ensured, and the mowing apparatus can perform effective cutting in a quieter and efficient manner as much as possible, thereby providing a more comfortable operating environment for the user.

Preferably, a ratio of a fan blade diameter D1 of the wind supplementing assembly 30 to a cutting diameter D of the cutting blade 22 satisfies: D1/D=0.3. In this way, by properly optimizing the ratio of the fan blade diameter D1 of the wind supplementing assembly 30 to the cutting diameter D of the cutting blade 22, air flow cooperation between the wind supplementing assembly 30 and the cutting assembly 20 is ensured, which is applicable to mowing regions of different sizes, such as a family garden and a public greenfield. In addition, by optimizing the ratio of the fan blade diameter of the wind supplementing assembly 30 to the cutting diameter of the cutting blade 22, the mowing apparatus can provide an optimal air flow cooperation effect in mowing regions of different sizes, and can maintain high-efficient mowing efficiency and collection of grass clippings both in a small range of a family garden and in a large area of a public greenfield, which is applicable to requirements of various mowing scenarios.

In an embodiment, as shown in FIG. 2 and FIG. 3, the mowing apparatus further includes a flange structure 70, a pad structure 80, and a locking bolt 90. After the flange structure 70 is sleeved on the cutting driving shaft 211, the cutting blade 22 is then sleeved on the cutting driving shaft 211, and the pad structure 80 is placed at a geometric center of the cutting blade 22. The locking bolt 90 passes through a via hole in the pad structure 80 and is connected to the cutting driving shaft 211.

### EMBODIMENT 2

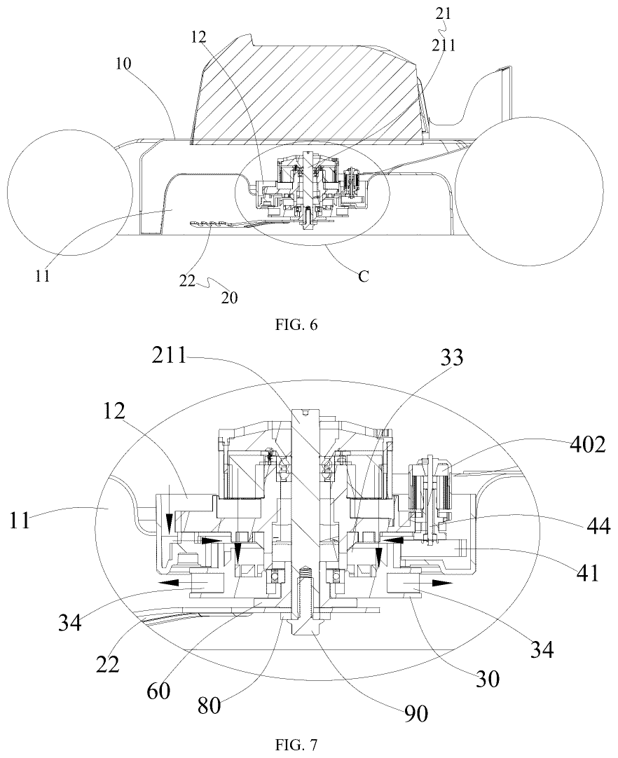

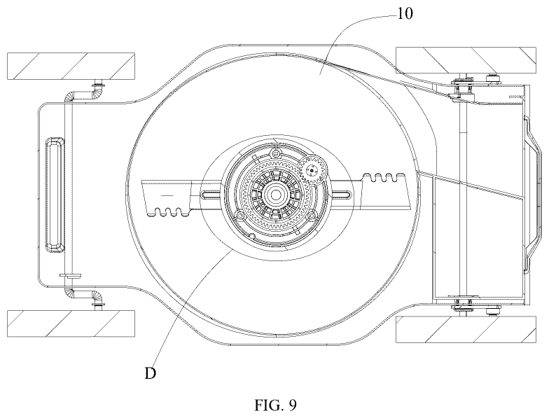

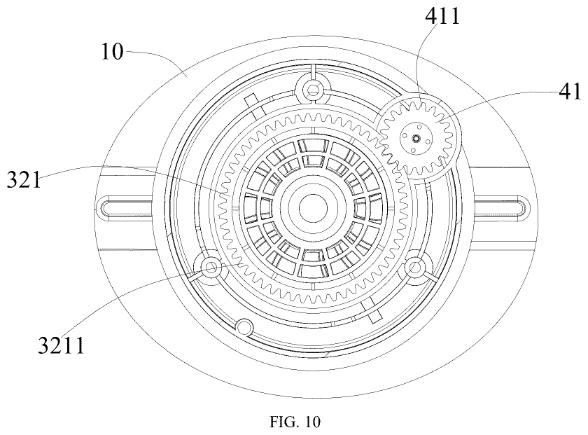

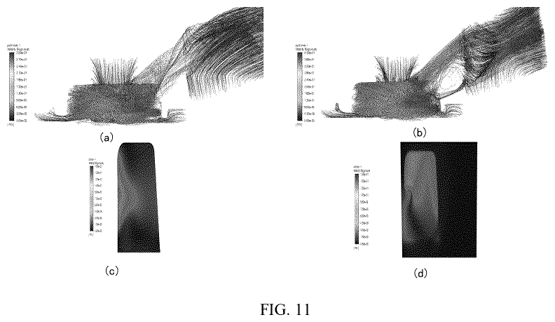

As shown in FIG. 6 to FIG. 10, a mowing apparatus includes a housing 10, a cutting assembly 20, a wind supplementing assembly 30, and a differential transmission assembly 40; the housing 10 has a cavity 11; the cutting assembly 20 includes a cutting motor 21 and a cutting blade 22, the cutting motor 21 is located at the cavity 11, and a cutting driving shaft 211 of the cutting motor 21 is drivingly connected to the cutting blade 22, so that the cutting blade 22 is rotatably arranged in the cavity 11; the wind supplementing assembly 30 is sleeved on the cutting driving shaft 211; and the differential transmission assembly 40 is arranged at the cavity 11 and configured to connect to the wind supplementing assembly 30; where the differential transmission assembly 40 includes a first transmission member 401 and a differential driving member, the differential driving member is a wind supplementing motor 402, the wind supplementing motor 402 is arranged at the cavity 11, the wind supplementing motor 402 has a fan driving shaft 44, the fan driving shaft 44 is linked with the first transmission member 401, and the first transmission member 401 is linked with the wind supplementing assembly 30; where the first transmission member 401 is driven by the differential driving member, so that a rotational speed of the wind supplementing assembly 30 is greater than a rotational speed of the cutting blade 22.

Compared with a conventional design in which an air flow is generated by only relying on rotation of the blade, to generate a limited flow condition, in the present application, the wind supplementing assembly 30 is sleeved on the cutting driving shaft 211, and the differential transmission assembly 40 is relied on to achieve a supercharging function, thereby improving air circulation effectiveness. The fan driving shaft 44 is linked with the first transmission member 401, and the first transmission member 401 is linked with the wind supplementing assembly 30. The first transmission member 401 is driven by the differential driving member, so that the rotational speed of the wind supplementing assembly 30 is always greater than the rotational speed of the cutting blade 22, thereby effectively enhancing a circulation capability of the air flow in the cavity 11 during a mowing operation of the mowing apparatus. Not only efficiency of pushing and expelling the grass clippings in the cavity 11 stage by stage is enhanced, but also a smooth condition in the cavity 11 is maintained, thereby improving mowing efficiency of the mowing apparatus. A collection effect of the grass clippings is optimized, the grass clippings are prevented from scattering around, comprehensive upgrading of a cleaning and energy saving capability is implemented, and user experience is improved.

In addition, by introducing the wind supplementing motor 402, the mowing apparatus can be flexibly adjusted for different lawn conditions or different working modes, so that the wind supplementing motor 402 can adjust output power thereof according to an actual requirement of a mowing process and maintain stable and highly efficient transmission, thereby implementing more accurate energy consumption control and ensuring operation economy of the apparatus. For example, when faced with a relatively thick lawn, power of the wind supplementing motor 402 can be independently increased to enhance an air flow effect, without replacing or adjusting a working condition of the cutting assembly 20. This independent transmission design of the wind supplementing motor 402 not only reduces a mechanical failure risk caused by overload or imbalance, but also can achieve power isolation, reduce noise and vibration, and improve overall stability and comfort of the apparatus.

In addition, introduction of the differential transmission assembly 40 enables the mowing apparatus to generate a stronger air flow during mowing. The apparatus is not only applicable to a common lawn, but also can maintain high-efficient mowing and grass clippings collection in complex environments such as high grass and wet grass, thereby improving environmental adaptability of the mowing apparatus.

Further, by introducing the differential transmission assembly 40, the rotational speed of the wind supplementing assembly 30 is significantly increased, and air flow strength of the mowing apparatus in a mowing process is effectively enhanced. Not only the mowing efficiency is improved, but also a collection effect of the grass clippings is optimized, so that the grass clippings are prevented from scattering around and user experience is improved. In addition, the independent design of the wind supplementing assembly 30 and the cutting assembly 20 enables the mowing apparatus to maintain good performance in different working environments, thereby improving adaptability and practicability of the mowing apparatus.

As shown in FIG. 6 and FIG. 7, the wind supplementing assembly 30 has an axial air guiding channel 33 and a radial air guiding channel 34 that are in communication with each other. The axial air guiding channel 33 is in communication with an air inlet of the cavity 11, and the radial air guiding channel 34 is in communication with the cavity 11. In this way, by setting the wind supplementing assembly 30 to have a structural form with an axial air guiding channel 33 and a radial air guiding channel 34 that are in communication with each other, a wind inlet direction of wind supplementing passes through the gap of the cutting assembly 20 and/or enters the cavity 11 through the wind supplementing assembly 30, thereby ensuring wind supplementing reliability of the wind supplementing assembly 30.

Further, introduction of the axial air guiding channel 33 and the radial air guiding channel 34 further optimizes guiding of air flows, can effectively guide external air to enter the cavity 11, properly distribute the air flows in the cavity 11, and generate continuous and stable air flows, which facilitates improving overall aerodynamic efficiency, improving efficiency of collecting grass clippings, effectively cooling the motor and other heat-sensitive components, avoiding a mechanical fault or efficiency reduction caused by a high temperature, reducing impact of air flows disturbance on a cutting path of the blade, and increasing accuracy and working efficiency of cutting.

In an embodiment, the fan driving shaft 44 and the cutting driving shaft 211 are not coaxial. In this way, the fan driving shaft 44 and the cutting driving shaft 211 are arranged to be not coaxial, so that the fan driving shaft 44 drives, by independently using the first transmission member 401, the wind supplementing assembly 30 to rotate, thereby ensuring the rotation reliability of the wind supplementing assembly 30, and the cutting driving shaft 211 independently drives the cutting blade 22, thereby ensuring the reliability of the cutting operation performed by the cutting blade 22.

As shown in FIG. 7 to FIG. 10, the wind supplementing assembly 30 includes a first wind supplementing fan 31 and a transmission fitting member 32, where the first wind supplementing fan 31 is sleeved on the cutting driving shaft 211; and the transmission fitting member 32 is connected to the first wind supplementing fan 31 and coupled to the first transmission member 401. In this way, by setting the wind supplementing assembly 30 into a structural form including the first wind supplementing fan 31 and the transmission fitting member 32, an augmented air flow pushing force in a high-speed rotation state is formed. The first wind supplementing fan 31 is closely coupled to the transmission fitting member 32 through the end surface, facilitating reducing a possibility that a local configuration bears impact and vibration, achieving a good rotation balance feature with minimum energy consumption, and achieving reliability of power transmission of the differential transmission assembly 40.

In an embodiment, the first wind supplementing fan 31 and the transmission fitting member 32 are integrally formed. In this way, it is beneficial to simplifying an overall structure of the wind supplementing assembly 30, reducing processing and manufacturing costs of the wind supplementing assembly 30, reducing assembly complexity and possible loosening or wearing risks between assemblies, improving connection stability between the first wind supplementing fan 31 and the transmission fitting member 32 of the wind supplementing assembly 30, and ensuring that power is more direct and smooth when transmitted from the differential transmission assembly 40 to the wind supplementing fan due to coupling of the transmission fitting member 32 to the first transmission member 401, reducing intermediate energy loss, and ensuring wind supplementing effectiveness of the first wind supplementing fan 31.

Further, the integrally formed first wind supplementing fan 31 and transmission fitting member 32 improve structural strength of the wind supplementing assembly 30, reduce deformation caused by high-speed rotation, and are applicable to a mowing environment that needs to be frequently moved and operated, such as agronomy and horticulture. In addition, internal friction and noise are also reduced, so that the mowing apparatus can maintain a stable working status and a relatively low noise level in a long-time high-strength mowing operation, for example, continuously work in a large park or a golf course, thereby improving operation experience of a user, and reducing interference to an ambient environment. The integrally formed first wind supplementing fan 31 and transmission fitting member 32 ensure structural stiffness of the wind supplementing assembly 30 at high-speed rotation, especially in an agronomic or horticultural scenario, for example, frequently moving to different plots or terrains. Structural deformation caused by high-speed rotation can be effectively reduced, a stable working state can be maintained, and a service life of the mowing apparatus is prolonged.

It should be noted that, in an embodiment of the present application that is not shown in the figure, the mowing apparatus further includes a third wind supplementing fan. The third wind supplementing fan is sleeved on the cutting driving shaft 211, and is connected to the differential transmission assembly 40. Alternatively, the third wind supplementing fan is connected to the second wind supplementing fan 50. The differential transmission assembly 40 drives the second wind supplementing fan 50 to rotate, to cause the third wind supplementing fan to rotate. The third wind supplementing fan may be integrally formed with the second wind supplementing fan 50. Alternatively, the third wind supplementing fan is connected to the second wind supplementing fan 50 through a transmission structure including, but not limited to, a form such as gear teeth. In this way, addition of the third wind supplementing fan further enhances strength and coverage of the air flow, can effectively improve the collection efficiency of the grass clippings especially when the mowing area is large, which is applicable to a mowing operation in a large lawn or grassland.

In an embodiment, the third wind supplementing fan is connected to an axial end surface of the differential transmission assembly 40.

Further, The integrally formed third wind supplementing fan and first gear structure 41 not only ensure structural strength of the wind supplementing assembly 30, but also optimizes air flow distribution, so that when the mowing apparatus processes a large lawn, such as a city park or a stadium, the mowing apparatus can gather and collect grass clippings more effectively, thereby reducing subsequent cleaning work and improving overall working efficiency.

In an embodiment, a value range of a transmission ratio i of the differential transmission assembly 40 satisfies: i>1; a value range of a rotational speed v1 of the wind supplementing motor 402 satisfies: v1>3000 rpm; and/or a value range of a rotational speed v2 of the wind supplementing assembly 30 satisfies: v2≤50000 rpm. In this way, by properly optimizing the value range of the transmission ratio i of the differential transmission assembly 40, and making i>1, it is ensured that the differential transmission assembly 40 is added to the mowing apparatus of the present application, so that the rotational speed of the wind supplementing assembly 30 is greater than the rotational speed of the cutting blade 22, thereby providing a high-efficient air flow in a cutting process. This air flow not only facilitates quickly discharging the cut grass clippings, but also facilitates cooling the cutting blade 22 and the motor, thereby reducing a temperature increase of the device caused by high-load work for a long time. In addition, by properly optimizing the value range of the rotational speed v1 of the wind supplementing motor 402, and making v1>3000 rpm, the high-speed air flow facilitates stabilizing operation of the mower, reducing ground resistance and body vibration, improving mowing fineness and mobility, and ensuring reliability of driving of the wind supplementing motor 402 to the wind supplementing assembly 30. In addition, by properly optimizing the value range of the rotational speed v2 of the wind supplementing assembly 30, and making v2≤50000 pm, on the premise that it is ensured that the rotational speed of the wind supplementing assembly 30 is greater than the rotational speed of the cutting blade 22, it is prevented that both the flux and the flow rate of air flow in the cavity 11 cannot meet a requirement for cutting grass due to the rotational speed v2 of the wind supplementing assembly 30 being excessively small,, thereby improving mowing efficiency of the mowing apparatus.

Further, according to the value range of the rotational speed v2 of the wind supplementing assembly 30 driven by the wind supplementing motor 402, a stronger air flow can be generated by the wind supplementing assembly 30 with a high rotational speed, further optimizing collection of grass clippings, which is applicable to an occasion having a strict requirement on grass clippings management, such as a golf course or a high-end residential region. In addition, in an occasion having a strict requirement on grass clippings management, such as a golf course or a high-end residential region, a high-rotational-speed design of the wind supplementing assembly 30 not only can generate a stronger air flow and effectively optimize grass clippings collection, but also can reduce impact of the grass clippings on operation of the mowing apparatus during a mowing process, thereby improving convenience of operation and aesthetics of a mowing effect, and satisfying pursuit of a user for high-quality mowing experience.

Preferably, the value range of the transmission ratio i of the differential transmission assembly 40 satisfies: 2≤i≤5. In this way, by properly optimizing the value range of the transmission ratio i of the differential transmission assembly 40, the rotational speed of the wind supplementing assembly 30 and the rotational speed of the cutting blade 22 may be optimized according to different mowing requirements and environmental conditions, so that the mowing apparatus is applicable to various scenarios from home gardens to professional lawn maintenance. In addition, an accurate transmission ratio is set, so that the mowing apparatus can automatically adjust the optimum rotational speed of the wind supplementing assembly 30 according to different lawn conditions and mowing requirements. Regardless of small-range mowing of a family garden or large-area maintenance of a professional lawn, the grass clippings can be efficiently and accurately collected and managed, thereby improving versatility and user convenience of the mowing apparatus.

Preferably, a value range of a rotational speed v1 of the wind supplementing motor 402 satisfies: 4000 rpm≤v1≤60000 rpm. In this way, the independent design and the high rotational speed of the wind supplementing motor 402 enable the mowing apparatus to maintain good performance in different working environments, thereby improving adaptability and practicability of the mowing apparatus, and being applicable to various mowing requirements, such as professional garden maintenance and farming operations. In addition, the independently designed wind supplementing motor 402 provides more flexible and high-efficient power support for the mowing apparatus in combination with a high rotational speed range of the wind supplementing motor. Especially in an occasion in which a wind supplementing effect needs to be precisely controlled, such as professional garden maintenance or farming operations, an optimum working state can be adjusted according to an actual requirement, thereby ensuring performance and practicability of the mowing apparatus, and satisfying diversified demands of professional mowing operations.

It should be noted that, in an embodiment, a ratio of a fan blade diameter D1 of the wind supplementing assembly 30 to a cutting diameter D of the cutting blade 22 satisfies: 0.05≤D1/D≤0.7. In this way, by properly optimizing a value range of the ratio of the fan blade diameter D1 of the wind supplementing assembly 30 to the cutting diameter D of the cutting blade 22, it is beneficial to properly adjusting a radial gap between the wind supplementing assembly 30 and the cutting blade 22, to optimize distribution of the air flow, so that in a process of a mowing operation of the mowing apparatus, mowing efficiency of the mowing apparatus is ensured, and the mowing apparatus can perform effective cutting in a quieter and efficient manner as much as possible, thereby providing a more comfortable operating environment for the user.

Preferably, a ratio of a fan blade diameter D1 of the wind supplementing assembly 30 to a cutting diameter D of the cutting blade 22 satisfies: D1/D=0.3. In this way, by properly optimizing the ratio of the fan blade diameter D1 of the wind supplementing assembly 30 to the cutting diameter D of the cutting blade 22, air flow cooperation between the wind supplementing assembly 30 and the cutting assembly 20 is ensured, which is applicable to mowing regions of different sizes, such as a family garden and a public greenfield. In addition, by optimizing the ratio of the fan blade diameter of the wind supplementing assembly 30 to the cutting diameter of the cutting blade 22, the mowing apparatus can provide an optimal air flow cooperation effect in mowing regions of different sizes, and can maintain high-efficient mowing efficiency and collection of grass clippings both in a small range of a family garden and in a large area of a public greenfield, which is applicable to requirements of various mowing scenarios.

As shown in FIG. 7 to FIG. 10, the first transmission member 401 includes a first gear structure 41, the fan driving shaft 44 is drivingly connected to the first gear structure 41, and the first gear structure 41 has a first tooth structure 411; the transmission fitting member 32 includes a second gear structure 321, the second gear structure 321 is sleeved on the cutting driving shaft 211, and the second gear structure 321 has a third tooth structure 3211 configured to mesh with the first tooth structure 411; and the first wind supplementing fan 31 is connected to an axial end surface of the second gear structure 321. In this way, the first gear structure 41 performs a power transmission function. The first gear structure 41 is driven to rotate by the fan driving shaft 44, and the second gear structure 321 is caused to rotate by means of meshing and cooperation between the first tooth structure 411 and the third tooth structure 3211, so as to drive the first wind supplementing fan 31 to rotate.

In an embodiment, the first wind supplementing fan 31 and the second gear structure 321 are integrally formed. In this way, it is beneficial to simplifying an entire structure of the wind supplementing assembly 30, and reducing processing and manufacturing costs of the wind supplementing assembly 30. In addition, connection stability between the first wind supplementing fan 31 and the second gear structure 321 of the wind supplementing assembly 30 can be improved, and under an action of coupling between the second gear structure 321 and the first transmission member 401, it is ensured that the second gear structure 321 reliably transmits power to the first wind supplementing fan 31, thereby ensuring wind supplementing effectiveness of the first wind supplementing fan 31.

Further, the integrally formed first wind supplementing fan 31 and second gear structure 321 improve structural strength of the wind supplementing assembly 30, reduce deformation caused by high-speed rotation, and are applicable to a mowing environment that needs to be frequently moved and operated, such as agronomy and horticulture. In addition, internal friction and noise are also reduced, so that the mowing apparatus can maintain a stable working status and a relatively low noise level in a long-time high-strength mowing operation, for example, continuously work in a large park or a golf course, thereby improving operation experience of a user, and reducing interference to an ambient environment. The integrally formed first wind supplementing fan 31 and second gear structure 321 ensure structural stiffness of the wind supplementing assembly 30 at high-speed rotation, especially in an agronomic or horticultural scenario, for example, frequently moving to different plots or terrains. Structural deformation caused by high-speed rotation can be effectively reduced, a stable working state can be maintained, and a service life of the mowing apparatus is prolonged.

It should be noted that, in an embodiment of the present application that is not shown in the figure, the first transmission member 401 includes a first transmission wheel, a second transmission wheel, and a transmission belt, and the fan driving shaft 44 is drivingly connected to the first transmission wheel; the second transmission wheel is sleeved on the cutting driving shaft 211, and the wind supplementing assembly 30 is connected to an axial end surface of the second transmission wheel; and two ends of the transmission belt are respectively sleeved on peripheral sides of the first transmission wheel and the second transmission wheel, to drive, by the second transmission wheel, the wind supplementing assembly 30 to rotate. In this way, by setting the first transmission member 401 into a structural form including the first transmission wheel, the second transmission wheel, and the transmission belt, a belt transmission manner or a chain transmission manner can provide more stable and efficient power transmission according to a specific design and use environment of the mowing apparatus, which is applicable to various designs of the mowing apparatus, such as a hand-propelled type, a self-walking type, or a remote-control type. In addition, the transmission manner of the belt or the chain not only provides stable and high-efficient power transmission, but also optimizes the design of the mowing apparatus, so that a good working status and operation experience can be maintained in various use environments for a mowing apparatus of a hand-propelled type, a self-walking type, or a remote-control type, thereby improving market competitiveness and user adaptability of the mowing apparatus.

It should be noted that, in an embodiment, the differential transmission assembly 40 is configured to adaptively adjust the rotational speed of the wind supplementing assembly 30 based on at least one of a first wind supplementing signal or a second wind supplementing signal of the mowing apparatus. The first wind supplementing signal is sent by operation on a controller of the mowing apparatus; and/or a second wind supplementing signal is sent based on at least one of a working condition parameter of the mowing apparatus, a cutting parameter of the cutting assembly 20, or an operating parameter of the mowing apparatus. The working condition parameter of the mowing apparatus includes a grass height, lawn humidity, and grass density. The cutting parameter of the cutting assembly 20 includes a cutting height level, a cutting load, a cutting current, and a cutting rotational speed. The operating parameter of the mowing apparatus includes a travelling speed of the mowing apparatus. In this way, by adjusting the rotational speed of the wind supplementing assembly 30 in real time, different lawn conditions such as the height, humidity, and density of the grass can be adapted, and strength of the wind assist is most adaptable in various cutting demands, so as to complete a mowing operation with optimal efficiency, thereby improving overall working efficiency. In addition, an overload situation of the cutting motor 21 can be prevented, thereby improving cutting quality and reducing wear of the blade. In addition, the rotational speed of the wind supplementing assembly 30 can be reduced when unnecessary, thereby reducing energy consumption and improving energy use efficiency of a device. This not only prolongs operating time of the device, but also reduces operating costs. This is beneficial to implementing a high-efficient and precise mowing operation. Such an intelligent mowing apparatus not only improves efficiency and effect of a mowing operation, but also brings more convenient and economic operation experience to a user. Especially in family users, the intelligent mowing apparatus can greatly reduce mowing time and energy, improve satisfaction and confidence levels of the user for the mowing apparatus, and is of great significance to push intelligent upgrade of the mowing apparatus market.

It should be noted that, in the present application, a preset wind supplementing rule of the mowing apparatus includes, but is not limited to, the following embodiments.

First, when a second wind supplementing signal is sent based on a working condition parameter in the preset wind supplementing rule, wind supplementing strength models corresponding to different grass heights are established, and corresponding wind supplementing strength is adjusted to when a detection apparatus detects a corresponding grass height.

Second, when a second wind supplementing signal is sent based on two parameters, namely, a working condition parameter and a cutting parameter in the preset wind supplementing rule, wind supplementing strength models corresponding to different grass heights are established and wind supplementing strength models corresponding to different cutting rotational speed/current/load parameters are established, and dynamic adjustment may be performed according to a set correspondence model such as an equal proportion/weight.

Further, the controller includes a detection module, a signal transmission module, and a control module, and the detection module is electrically connected to the cutting assembly 20, to obtain an electrical signal of the cutting assembly 20; the signal transmission module has a signal receiving end and a signal sending end, and the signal receiving end is communicably connected to the detection module, so as to receive an electrical signal; and the signal sending end is communicably connected to the control module, and the control module is operably connected to the wind supplementing motor 402, so that the control module adjusts the rotational speed of the wind supplementing motor 402 in real time based on the electrical signal. In this way, it is beneficial to implementing precise regulation on the rotational speed of the wind supplementing motor 402.

Further, the mowing apparatus further includes a detector, and the detector is electrically connected to the cutting assembly 20, to obtain an electrical signal of the cutting assembly 20; the controller includes a signal transmission module and a control module, the signal transmission module has a signal receiving end and a signal sending end, and the signal receiving end is communicably connected to the detector, so as to receive an electrical signal; and the signal sending end is communicably connected to the control module, and the control module is operably connected to the wind supplementing motor 402, so that the control module adjusts the rotational speed of the wind supplementing motor 402 in real time based on the electrical signal. In this way, it is beneficial to implementing precise regulation on the rotational speed of the wind supplementing motor 402.

In an embodiment, an active control manner may be that a controller such as a control panel of the mowing apparatus provides electrical signal control or a key or a handle in a push rod performs mechanical control, an APP interface operation, or the like, or the wind supplementing strength of the wind supplementing fan is adaptively adjusted based on a wind supplementing signal of a device and/or based on a working condition parameter including a grass height, grass humidity, and grass density; a cutting parameter including a cutting level, a cutting load, a cutting current, and a cutting speed; and an operating parameter of the entire machine including a height increasing level and a travelling speed or a rotational speed of the mowing apparatus.

In an embodiment, the controller may be a control panel, or certainly may be a control button, or a touchscreen panel.

In an embodiment, the wind supplementing signal is adjusted based on an actual cutting working condition including a ground clearance, lawn density, lawn humidity, and the like and/or an extra centrifugal wind speed is adaptively provided, i.e., the rotational speed is adaptively increased, based on a working condition parameter including a grass height, grass humidity, and grass density; a cutting parameter including a cutting level, a cutting load, a cutting current, and a cutting speed; and an operating parameter of the entire machine including a height increasing level and a travelling speed or a rotational speed of the mowing apparatus, thereby superimposing and speeding up air flow in the air duct to improve circulation efficiency of grass clippings in the air duct.

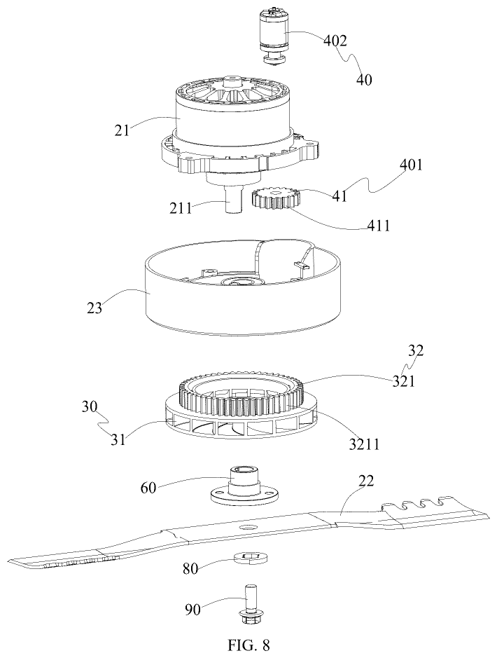

In an embodiment, as shown in FIG. 7 and FIG. 8, the mowing apparatus further includes a spiral retainer ring 60, a pad structure 80, and a locking bolt 90. After the spiral retainer ring 60 is sleeved on the cutting driving shaft 211, the cutting blade 22 is then sleeved on the cutting driving shaft 211, and the pad structure 80 is placed at a geometric center of the cutting blade 22. The locking bolt 90 passes through a via hole in the pad structure 80 and is connected to the cutting driving shaft 211.

It should be noted that terms used herein are only for describing specific embodiments and are not intended to limit exemplary embodiments according to the present application. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

Unless otherwise specifically stated, relative arrangements of components and steps, numerical expressions, and numerical values described in these embodiments do not limit the scope of the present application. In addition, it should be understood that for ease of description, the sizes of the parts shown in the accompanying drawings are not drawn according to an actual proportional relationship. Technologies, methods, and devices known by a person of ordinary skill in the relevant art may not be discussed in detail, but the technologies, methods, and devices should be considered as a part of the authorization specification in proper circumstances. In all examples shown and discussed herein, any specific value should be interpreted as merely an example, rather than a limitation. Therefore, other examples of the exemplary embodiments may have different values. It should be noted that similar numbers and letters represent similar items in the following accompanying drawings. Therefore, once an item is defined in one of the accompanying drawings, the item does not need to be further discussed in subsequent accompanying drawings.

For ease of description, spatial relative terms such as “on”, “above”, “on an upper surface”, and “upper” may be used herein to describe a spatial position relationship between one device or feature and another device or feature shown in the figures. It should be understood that the spatial relative terms are intended to include different orientations in use or operation other than those described by the device in the figure. For example, if the device in the drawings is inverted, the device described as “above another device or structure” or “on top of another device or structure” will then be positioned as “below the another device or structure” or “under the another device or structure.” Therefore, an exemplary term “above” may include two orientations, namely, “above” and “below”. The device may also be positioned in other different manners, for example, rotated by 90 degrees or at other orientations, and relative spatial descriptions used herein are correspondingly explained.

It should be noted that terms used herein are only for describing specific embodiments and are not intended to limit exemplary embodiments according to the present application. As used herein, unless the context explicitly indicates otherwise, the singular form is also intended to include the plural form. Additionally, it should be understood that when the terms “comprising” and/or “including” are used in this specification, they are intended to indicate the presence of features, steps, operations, devices, components, and/or their combinations.

It should be noted that, in the specification, claims, and accompanying drawings of the present application, the terms “first”, “second”, and the like are intended to distinguish between similar objects but do not necessarily indicate a specific order or sequence. It is to be understood that the terms used in such a way are interchangeable in a proper circumstance, so that the embodiments of the present application described herein can be implemented in orders except the order illustrated or described herein.

The foregoing descriptions are merely preferred embodiments of the present application, but are not intended to limit the present application. A person skilled in the art may make various alterations and variations to the present application. Any modification, equivalent replacement, or improvement and the like made within the spirit and principle of the present application shall fall within the protection scope of the present application.

What is claimed is:

1. A mowing apparatus, comprising:
a housing, the housing having a cavity;
a cutting assembly, the cutting assembly comprising a cutting motor and a cutting blade, the cutting motor being located at the cavity, and a cutting driving shaft of the cutting motor being drivingly connected to the cutting blade, so that the cutting blade is rotatably arranged in the cavity;
a wind supplementing assembly, the wind supplementing assembly being sleeved on the cutting driving shaft; and
a differential transmission assembly, the differential transmission assembly being arranged at the cavity and configured to drive the wind supplementing assembly, the differential transmission assembly comprising a first transmission member and a differential driving member, the first transmission member being linked with the wind supplementing assembly, and the differential driving member being linked with the first transmission member;
wherein the first transmission member is driven by the differential driving member, so that a rotational speed of the wind supplementing assembly is greater than a rotational speed of the cutting blade.

2. The mowing apparatus according to claim 1, wherein a power source of the differential transmission assembly is the cutting assembly, and the cutting driving shaft and the wind supplementing assembly are arranged coaxially.

3. The mowing apparatus according to claim 2, wherein the wind supplementing assembly comprises:
a first wind supplementing fan, the first wind supplementing fan being sleeved on the cutting driving shaft; and
a transmission fitting member, the transmission fitting member being connected to the first wind supplementing fan and coupled to the first transmission member;
wherein the first wind supplementing fan is connected to an axial end surface of the transmission fitting member.

4. The mowing apparatus according to claim 3, wherein
the first transmission member comprises:
a first gear structure, the cutting driving shaft being drivingly connected to the first gear structure, and the first gear structure having a first tooth structure; and
a fixing bracket, the fixing bracket being arranged at the cavity and the fixing bracket being connected to the housing, the fixing bracket being provided with at least two planet gears, and each of the at least two planet gears having a second tooth structure configured to mesh with the first tooth structure; and
the transmission fitting member comprises:
a second gear structure, the second gear structure being sleeved on the cutting driving shaft, and the second gear structure having a third tooth structure configured to mesh with the second tooth structure.

5. The mowing apparatus according to claim 1, wherein
a value range of a transmission ratio i of the differential transmission assembly satisfies: i>0.01;
a value range of a rotational speed v1 of the cutting motor satisfies: 2000 rpm≤v1≤5000 rpm; and/or
a value range of a rotational speed v2 of the wind supplementing assembly satisfies: v2>2000 rpm.

6. The mowing apparatus according to claim 5, wherein
the value range of the transmission ratio i of the differential transmission assembly satisfies: 0.2≤i≤0.7.

7. The mowing apparatus according to claim 4, wherein the mowing apparatus further comprises:
a second wind supplementing fan, the second wind supplementing fan being sleeved on the cutting driving shaft and being connected to an axial end surface of the differential transmission assembly, wherein
the second wind supplementing fan and the first gear structure are integrally formed; and/or
the second wind supplementing fan is connected to an axial end surface of the first gear structure.

8. The mowing apparatus according to claim 1, wherein
a ratio of a fan blade diameter D1 of the wind supplementing assembly to a cutting diameter D of the cutting blade satisfies: 0.05≤D1/D≤0.7.

9. A mowing apparatus, comprising:
a housing, the housing having a cavity;
a cutting assembly, the cutting assembly comprising a cutting motor and a cutting blade, the cutting motor being located at the cavity, and a cutting driving shaft of the cutting motor being drivingly connected to the cutting blade, so that the cutting blade is rotatably arranged in the cavity;
a wind supplementing assembly, the wind supplementing assembly being sleeved on the cutting driving shaft; and
a differential transmission assembly, the differential transmission assembly being arranged at the cavity and configured to connect to the wind supplementing assembly;
wherein the differential transmission assembly comprises a first transmission member and a differential driving member, the differential driving member is a wind supplementing motor, the wind supplementing motor is arranged at the cavity, the wind supplementing motor has a fan driving shaft, the fan driving shaft is linked with the first transmission member, and the first transmission member is linked with the wind supplementing assembly; and
the first transmission member is driven by the differential driving member, so that a rotational speed of the wind supplementing assembly is greater than a rotational speed of the cutting blade.

10. The mowing apparatus according to claim 9, wherein the wind supplementing assembly has an axial air guiding channel and a radial air guiding channel that are in communication with each other, the axial air guiding channel is in communication with an air inlet of the cavity, and the radial air guiding channel is in communication with the cavity.

11. The mowing apparatus according to claim 9, wherein the fan driving shaft and the cutting driving shaft are not coaxial.

12. The mowing apparatus according to claim 9, wherein the wind supplementing assembly comprises:
a first wind supplementing fan, the first wind supplementing fan being sleeved on the cutting driving shaft; and
a transmission fitting member, the transmission fitting member being connected to the first wind supplementing fan and coupled to the first transmission member.

13. The mowing apparatus according to claim 9, wherein
a value range of a transmission ratio i of the differential transmission assembly satisfies: i>1;
a value range of a rotational speed v1 of the wind supplementing motor satisfies: v1>3000 rpm; and/or
a value range of a rotational speed v2 of the wind supplementing assembly satisfies: v2≤50000 rpm.

14. The mowing apparatus according to claim 13, wherein
the value range of the transmission ratio i of the differential transmission assembly satisfies: 2≤i≤5.

15. The mowing apparatus according to claim 13, wherein
the value range of the rotational speed v1 of the wind supplementing motor satisfies: 4000 rpm≤v1≤60000 rpm.

16. The mowing apparatus according to claim 9, wherein
a ratio of a fan blade diameter D1 of the wind supplementing assembly to a cutting diameter D of the cutting blade satisfies: 0.05≤D1/D≤0.7.

17. The mowing apparatus according to claim 9, wherein
the differential transmission assembly is configured to adaptively adjust the rotational speed of the wind supplementing assembly based on at least one of a first wind supplementing signal or a second wind supplementing signal of the mowing apparatus;
wherein the first wind supplementing signal is sent by operation on a controller of the mowing apparatus; and/or
the second wind supplementing signal is sent based on at least one of a working condition parameter of the mowing apparatus, a cutting parameter of the cutting assembly, or an operating parameter of the mowing apparatus, wherein
the working condition parameter of the mowing apparatus comprises a grass height, lawn humidity, and grass density;
the cutting parameter of the cutting assembly comprises a cutting height level, a cutting load, a cutting current, and a cutting rotational speed; and
the operating parameter of the mowing apparatus comprises a travelling speed of the mowing apparatus.

18. The mowing apparatus according to claim 17, wherein the controller comprises:
a detection module, the detection module being electrically connected to the cutting assembly, to obtain an electrical signal of the cutting assembly;
a signal transmission module, the signal transmission module having a signal receiving end and a signal sending end, and the signal receiving end being communicably connected to the detection module, so as to receive the electrical signal; and
a control module, the signal sending end being communicably connected to the control module, and the control module being operably connected to the wind supplementing motor, so that the control module adjusts the rotational speed of the wind supplementing motor in real time based on the electrical signal.

19. The mowing apparatus according to claim 17, wherein the mowing apparatus further comprises:
a detector, the detector being electrically connected to the cutting assembly, to obtain an electrical signal of the cutting assembly; and
the controller comprises:
a signal transmission module, the signal transmission module having a signal receiving end and a signal sending end, and the signal receiving end being communicably connected to the detector, so as to receive the electrical signal; and
a control module, the signal sending end being communicably connected to the control module, and the control module being operably connected to the wind supplementing motor, so that the control module adjusts the rotational speed of the wind supplementing motor in real time based on the electrical signal.
